(19) United States
(12) Patent Application Publication
(10) Pub. No.: US 2024/0205245 A1
(43) Pub. Date: Jun. 20, 2024

(54) METHOD AND SYSTEM OF FILTERING OUT ALERTS THAT TRIGGER ON LEGITIMATE ACTIVITY

(71) Applicant: VMware, Inc., Palo Alto, CA (US)

(72) Inventors: Ritika SINGHAL, San Jose, CA (US); Jonathan James OLIVER, Kew (AU); Shugao XIA, Newton, MA (US); Aditya CHOUDHARY, San Jose, CA (US); Raghav BATTA, Livermore, CA (US)

(21) Appl. No.: 18/068,484

(22) Filed: Dec. 19, 2022

(51) Int. Cl. H04L 9/40; G06F 9/455

(52) U.S. Cl. CPC H04L 63/1425; G06F 9/45558; H04L 63/1416; G06F 2009/45587; G06F 2009/45595

(57) ABSTRACT

A method of filtering out new alerts generated by a security agent installed in an endpoint is based on cluster profile data of clusters that were generated by applying a clustering algorithm to locality-sensitive hash (LSH) values of prior alerts. The method includes the steps of: storing cluster profile data of each cluster that is part of a subset of the clusters; generating an LSH value of a new alert generated by the security agent; and determining that the new alert belongs to one of the clusters in the subset based on the LSH value of the new alert and, in response to said determining, filtering out the new alert from a group of alerts that require further investigation.

### BACKGROUND

It has become increasingly critical for security systems to generate contextual, timely, and actionable alerts such that security analysts can initiate speedy mitigation measures. Unfortunately, in a typical security operations center, the number of alerts that are generated far outnumber the number of security analysts that can effectively triage them. As a result, critical alerts are often missed by the security analysts due to fatigue and burnout. In addition, many critical alerts are identified too late for mitigation measures to be effective.

One way to mitigate the large number of alerts that are generated is to add exceptions to watchlist rules that trigger the alerts. However, the use of exceptions cause an increase in the attack surface. For example, when a watchlist rule is created to trigger alerts to catch suspicious command lines being executed, but exceptions are added to the rule to minimize the number of alerts that are generated as of result of legitimate command lines being executed, the command lines of an attacker could be modified in view of the exception list so that they do not trigger alerts and thus are able to evade detection.

### SUMMARY

One or more embodiments provide a method of filtering out alerts that are generated by security agents installed in endpoints so that the alerts that are generated as a result of legitimate activity, hereinafter referred to as “noisy” alerts, are suppressed. The method does not employ exceptions and therefore an increase in the attack surface resulting from the use of exceptions is prevented.

A method of filtering out new alerts generated by a security agent installed in an endpoint, according to embodiments, is based on cluster profile data of clusters that were generated by applying a clustering algorithm to locality-sensitive hash (LSH) values of prior alerts. The method includes the steps of: storing cluster profile data of each cluster that is part of a subset of the clusters; generating an LSH value of a new alert generated by the security agent; and determining that the new alert belongs to one of the clusters in the subset based on the LSH value of the new alert and, in response to said determining, filtering out the new alert from a group of alerts that require further investigation.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtual computing environment which employs a cloud-based security platform according to embodiments.

FIG. 2 is a block diagram that illustrates components of the cloud-based security platform that are employed in filtering out alerts according to an embodiment.

FIG. 3 is a diagram that illustrates a sequence of commands issued and operations carried out to generate clusters by the components of the cloud-based security platform.

FIG. 4 is a flow diagram of a method of filtering out alerts according to an embodiment.

FIG. 5 is a block diagram that illustrates components of a security agent that are employed in filtering out alerts according to another embodiment.

FIG. 6 is a diagram that illustrates a sequence of commands issued and operations carried out to generate clusters by the components of the security agent.

FIG. 7 is a flow diagram of a method of filtering out alerts according to another embodiment.

### DETAILED DESCRIPTION

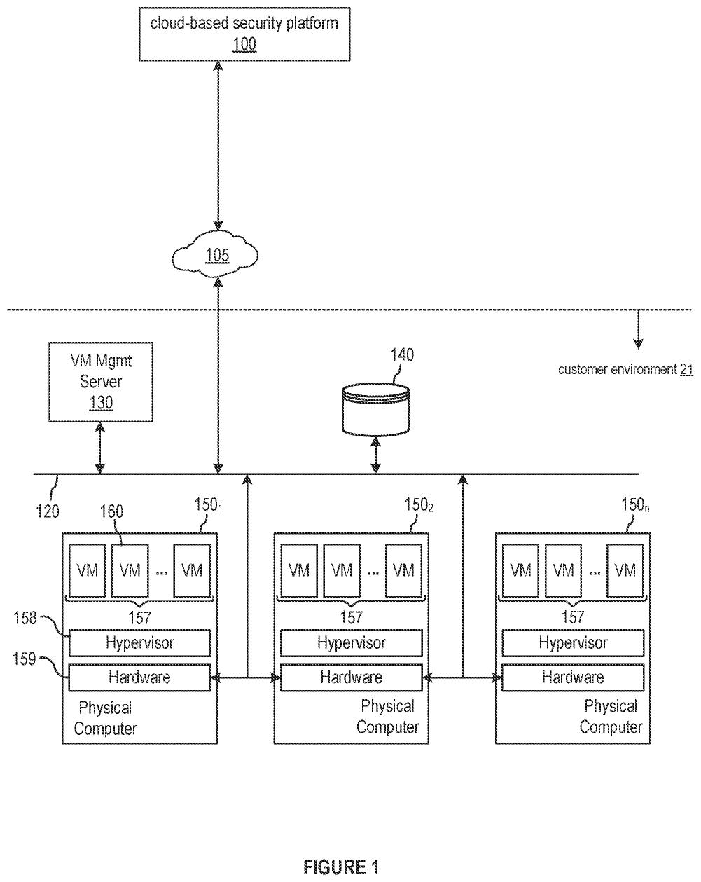

FIG. 1 is a block diagram of a virtual computing environment which is deployed in a customer environment 21 and employs a cloud-based security platform 100, according to embodiments. In the embodiments illustrated herein, virtual computing instances that are provisioned in the virtual computing environment are VMs, and the provisioning of the VMs are managed by a VM management server 130. In some embodiments, virtual computing instances provisioned in the virtual computing environment are containers.

As used herein, a “customer” is an organization that has subscribed to security services offered through cloud-based security platform 100. A “customer environment” means one or more private data centers managed by the customer, which is commonly referred to as “on-prem,” a private cloud managed by the customer, a public cloud managed for the customer by another organization, or any combination of these.

As illustrated in FIG. 1, VMs 157 are deployed on a plurality of physical computers 150₁, 150₂ . . . 150ₙ, (also referred to as “host computers”), which VM management server 130 manages as a cluster to provide cluster-level functions, such as load balancing across the cluster through VM migration between the hosts, distributed power management, dynamic VM placement according to affinity and anti-affinity rules, and high availability (HA). VM management server 130 also manages a shared storage device 140 and provisions storage resources for the cluster (e.g., one or more virtual disks for each of VMs 157) from shared storage device 140.

Each of the host computers includes a hypervisor 158 (more generally, “virtualization software”) and a hardware platform 159. Hardware platform 159 contains components of a conventional computer system, such as one or more central processing units, system memory in the form of dynamic and/or static random access memory, one or more network interface controllers connected to a network 120, and a host bus adapter connected to shared storage 140. In some embodiments, hardware platform 159 includes a local storage device, such as a hard disk drive or a solid state drive, and the local storage devices of the host computers are aggregated and provisioned as shared storage device 140.

In the embodiments, security services are provided to various security endpoints, which include VMs 157, through a cloud-based security platform 100, which includes a plurality of services, each of which is running in a container or a VM that has been deployed on a virtual infrastructure of a public cloud computing system. To enable delivery of security services to VMs 157, security agents are installed in VMs 157 and the security agents communicate with cloud-based security platform 100 over a public network 105, e.g., the Internet.

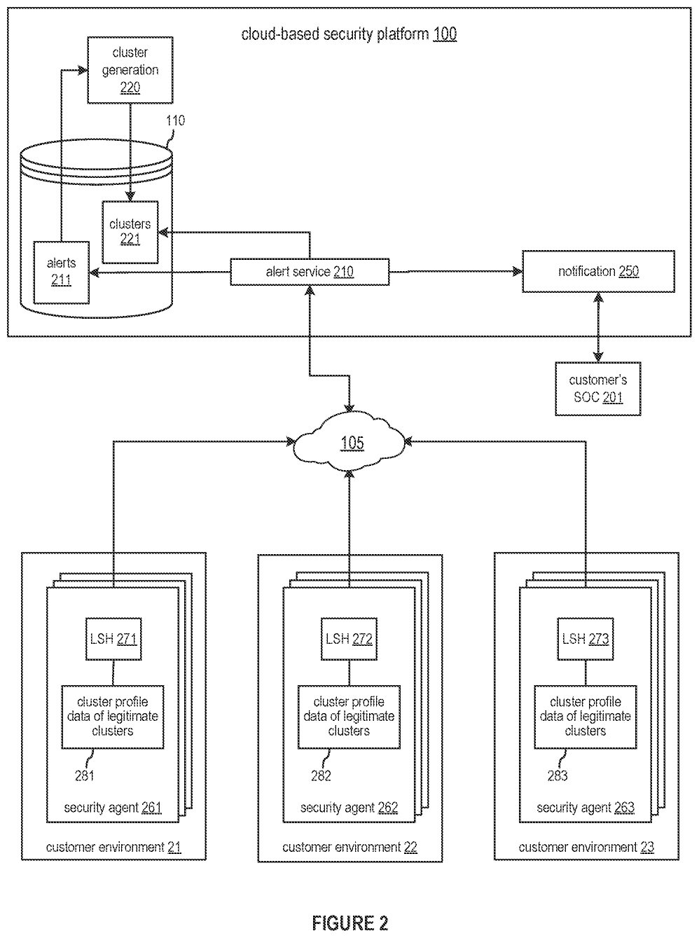

As illustrated in FIG. 2, the services include an alert service 210, a cluster generation service 220, and a notification service 250. Cloud-based security platform 100 also maintains databases in a storage device 110. The databases include an alerts database 211 and a clusters database 221.

Alert service 210 routes security alerts that are transmitted to cloud-based security platform 100 by security agents installed in VMs which are provisioned in customer environments that employ security services provided by cloud-based security platform 100. In FIG. 2, three different customer environments, including customer environments 21, 22, 23 depicted in FIG. 1, are shown as an example. The security agents that transmit security alerts to cloud-based security platform 100 include security agents 261 that are installed in VMs of customer environment 21, security agents 262 that are installed in VMs of customer environment 22, and security agents 263 that are installed in VMs of customer environment 23.

Each security agent 261, 262, 263 includes a locality-sensitive hash (LSH) module for computing a locality-sensitive hash of the security alerts prior to transmitting them to cloud-based security platform 100. Therefore, any sensitive information contained in the security alerts is not transmitted to cloud-based security platform 100 in its raw form. As such, the security alerts handled by alert service 210 are not in their raw form. Instead, they are the LSH of the security alerts in their raw form or the LSH of the security alerts in their raw form that have been transformed in some manner. Example transforms include conversion into lowercase and applying a regular expression. Hereinafter, the security alerts in their raw form will be referred to as “raw security alerts” and the LSH of the raw security alerts or the LSH of transforms of the raw security alerts will be referred to as “LSH security alerts.” In one embodiment, an LSH module that generates a locality-sensitive hash known in the art as TLSH is used in each of security agents 261, 262, 263. This LSH module is depicted in FIG. 2 as LSH 271 in security agent 261, LSH 272 in security agent 262, and LSH 273 in security agent 263.

In the embodiments, the security agents monitor rules (e.g., watchlist rules) that security domain experts of the corresponding organization have written, and generate security alerts when the conditions of any of the rules are satisfied. For example, one rule may specify that any execution of a PowerShell® command-line should be a trigger for a security alert. In such a case, each time a PowerShell® command-line is executed in a VM, the security agent installed in the same VM generates a corresponding security alert. In addition, the security agents transmit the security alerts to cloud-based security platform 100 along with various attributes of the security alerts. The attributes of each security alert include: (1) timestamp indicating the date and time the security alert was generated, (2) device ID of the endpoint (e.g., VM) in which the security agent that generated the security alert is installed, (3) organization ID of the organization to which the endpoint belongs, and (4) rule ID that identifies the rule which triggered the security alert.

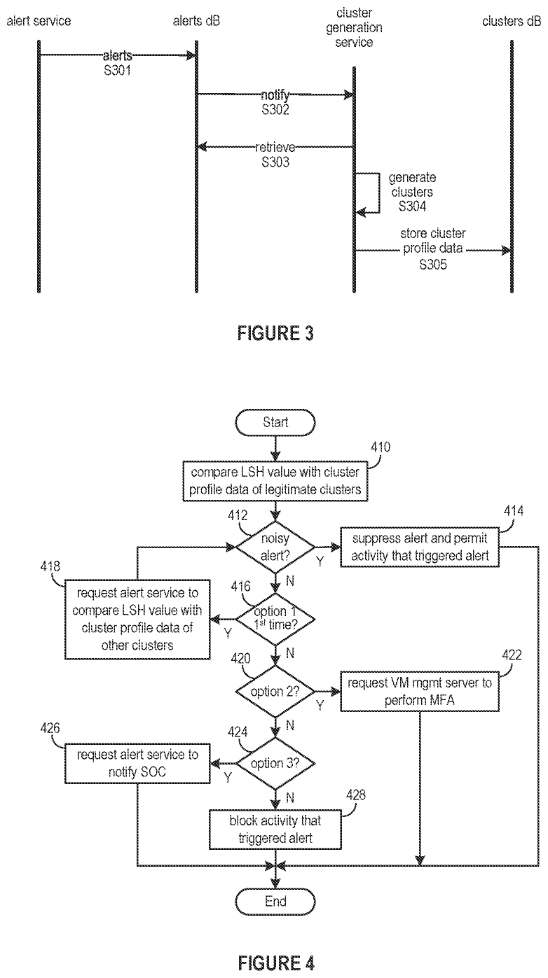

Alert service 210 routes the LSH security alerts to alerts database 211. FIG. 3 depicts a series of steps that are performed in connection with the LSH security alerts routed to alerts database 211, starting with the collection of the LSH security alerts in alerts database 211 (step S301). When a threshold number of LSH security alerts are collected in alerts database 211 for processing, cluster generation service 220 is notified at step S302. In response to this notification, cluster generation service 220 retrieves the group of LSH security alerts collected for processing at step S303 and generates clusters based on the group of LSH security alerts at step S304. Any of the well-known clustering algorithms, e.g., density-based spatial clustering of applications with noise (DBSCAN), k-means, Gaussian mixture models (GMM), and hierarchical agglomerative clustering (HAC), may be applied to the group of LSH security alerts to generate the clusters. After the clusters are generated, for each of the clusters, cluster generation service 220 computes a centroid, which is representative of the center all of the LSH security alerts in the cluster, and generates statistical and behavioral properties of the cluster. In one embodiment, the centroid is computed as an average of all LSH values of all of the LSH security alerts in the cluster, and the statistical and behavioral properties of the cluster include radius of the cluster, number of unique security alerts in the cluster, whether the security alert is generated as a result of an execution of code that is backed by a certificate, cluster density, and cluster variance. At step S305, the cluster profile data of each of the clusters generated at step S304, which includes its centroid and its statistical and behavioral properties, are stored in clusters database 221.

FIG. 4 is a flow diagram of a method of filtering out alerts according to an embodiment. This method relies on cluster profile data of legitimate clusters, which are a subset of the clusters having cluster profile data stored in clusters database 221. The cluster profile data of legitimate clusters are stored in a memory space accessible by the security agents. In the example illustrated in FIG. 2, security agent 261 has an accessible memory space 281 (e.g., in the VM where security agent 261 is installed) in which the cluster profile data of legitimate clusters are stored. Similarly, security agent 262 has an accessible memory space 282 (e.g., in the VM where security agent 262 is installed) in which the cluster profile data of legitimate clusters are stored, and security agent 263 has an accessible memory space 283 (e.g., in the VM where security agent 263 is installed) in which the cluster profile data of legitimate clusters are stored.

In the embodiments, filtering techniques are implemented to identify the legitimate clusters. The filtering in one such example is carried out based on the cluster density and the cluster variance. Clusters with high densities (e.g., greater than a minimum density) and low variances (e.g., less than a maximum variance) are likely to contain legitimate alerts, and are selected as legitimate clusters. As a result, an average cluster density of the legitimate clusters is greater than an average cluster density of the non-legitimate clusters, and an average cluster variance of the legitimate clusters in the subset is less than an average cluster variance of the non-legitimate clusters.

The method of FIG. 4 is carried out by a security agent (e.g., any of security agents 261, 262, 263) after alert service 210 performs the filtering described above and transmits the cluster profile data of legitimate clusters to the different customer environments, and is triggered when the security agent generates an LSH security alert as described above, e.g., when the conditions of any of the watchlist rules are satisfied. At step 410, the security agent compares the LSH value of the security alert with the cluster profile data of legitimate clusters to determine if the security alert belongs to any of the legitimate clusters. Any of the well-known techniques may be used to determine whether the security alert belongs to any of the legitimate clusters. In one embodiment, the security agent performs distance calculations between the security alert and the legitimate clusters (in particular, between the LSH value of the security alert and centroids of the legitimate clusters), and determines that the security alert does not belong to any of the legitimate clusters if all of the calculated distances are greater than a threshold distance. On the other hand, if one or more of the calculated distances are within the threshold distance, the security alert is determined to belong to the legitimate cluster that is closest thereto.

If the security alert belongs to a legitimate cluster, the security alert is deemed to be a “noisy” alert that can be suppressed. Thus, if the security alert is a noisy alert (step 412, Y), the security agent at step 414 suppresses the security alert and permits the activity that triggered the security alert, e.g., permits execution of a command. The method ends after step 414.

On the other hand, if the security alert is deemed not to be a noisy alert (step 412, N), one of four options are available, and the security agent carries out the method of FIG. 4 according to an option setting (which is set, for example, by a security administrator of the VM in which the security agent is installed).

If option 1 is set (step 416, Y), the security agent requests alert service 210 in cloud-based security platform 100 to compare the LSH value of the security alert with the cluster profile data of other clusters (i.e., those which were not determined to be legitimate clusters but also not known to be associated with malicious activities). In response, alert service 210 performs distance calculations between the security alert and these other clusters to determine if the security alert belongs to any of these other clusters in the same manner as carried out by the security agent at step 410 described above, and returns the result of its determination to the security agent. If the security alert belongs to any of these other clusters, it is deemed to be a noisy alert at step 412 and the security agent executes step 414 thereafter. If the security alert does not belong to any of these other clusters, the activity that triggered the security alert is deemed to be potentially malicious and the security agent executes step 428 next to block the activity. Some embodiments, however, may permit option 2 or option 3 to be set in addition to option 1. In such cases, the steps associated with option 2 or option 3 will be additionally executed as described below.

If option 2 is set (step 420, Y), the security agent at step 422 requests VM management server 130 to perform multi-factor authentication (MFA) on the activity that triggered the security alert. For example, if a command line is entered for execution and this activity triggered the security alert, VM management server 130 executes a series of MFA steps to confirm that the user that entered this command line is a legitimate user and not an attacker. If MFA is successful, the activity will be permitted. However, if MFA is not successful, the activity will be blocked.

If option 3 is set (step 424, Y), the security agent at step 426 requests alert service 210 to notify security operation center 201 associated with the customer environment in which the security alert was generated. In response, alert service 210 issues a notification to security operation center 201 through notification service 250. In this case, a further investigation of the activity that triggered the security alert and a decision whether to permit the activity or block the activity will be carried out there.

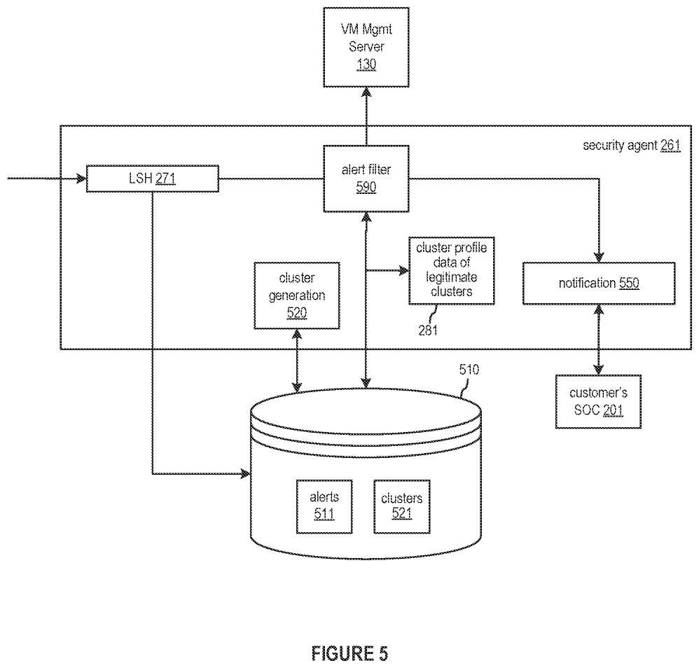

FIG. 5 is a block diagram that illustrates components of a security agent that are employed in filtering out alerts according to another embodiment. This embodiment differs from the embodiment described above in conjunction with FIGS. 2-4 in that the components of a security agent (depicted in FIG. 5 as security agent 261) is collecting security alerts, generating clusters based on the collected security alerts, and carrying out the filtering to identify the legitimate clusters. These components include a cluster generation module 520 and an alert filter module 590. In addition to these components, the security agent maintains an alerts database 511 and clusters database 521 in storage device 510, which is, for example, a virtual disk for the virtual machine in which the security agent is installed.

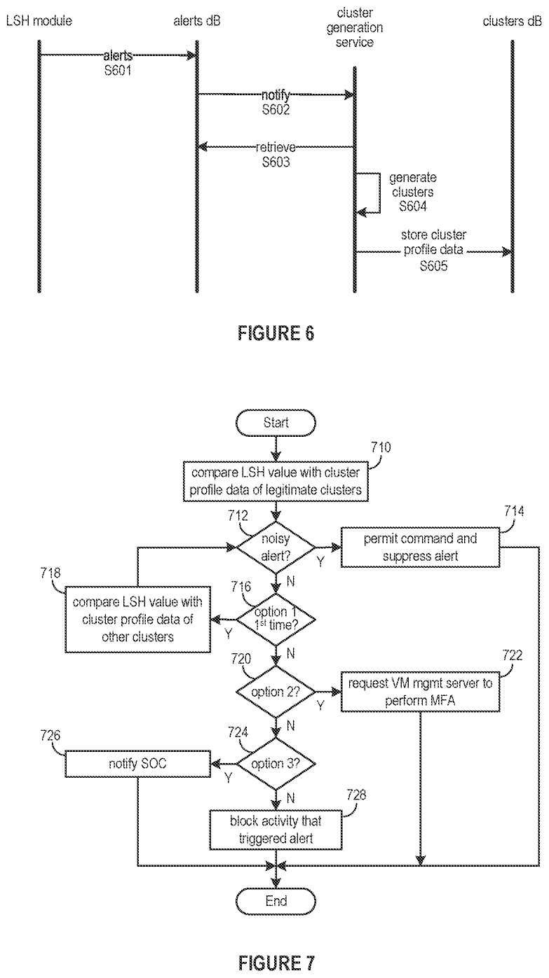

FIG. 6 is a diagram that illustrates a sequence of commands issued and operations carried out to generate clusters by the components of the security agent. The first step depicted in FIG. 6 is step S601 which represents the generation of LSH security alerts by LSH module 271 when raw security alerts are triggered (e.g., when the conditions of any of the watchlist rules are satisfied), and the collection of the LSH security alerts in alerts database 511. When a threshold number of LSH security alerts are collected in alerts database 511 for processing, cluster generation service 520 is notified at step S602. In response to this notification, cluster generation module 520 retrieves the group of LSH security alerts collected for processing at step S603 and generates clusters based on the group of LSH security alerts at step S604. Any of the well-known clustering algorithms (examples of which are listed above) may be applied to the group of LSH security alerts to generate the clusters. After the clusters are generated, for each of the clusters, cluster generation module 520 computes the centroid and generates statistical and behavioral properties of the cluster in the same manner as cluster generation service 220 described above. At step S605, the cluster profile data of each of the clusters generated at step S604, which includes its centroid and its statistical and behavioral properties, are stored in clusters database 521.

FIG. 7 is a flow diagram of a method of filtering out alerts according to another embodiment. As with the method of FIG. 4, this method relies on cluster profile data of legitimate clusters. However, the legitimate clusters employed in the method of FIG. 7 are filtered from a different base set of clusters than in the method of FIG. 4. In the method of FIG. 4, the legitimate clusters are filtered from a base set of clusters that are generated from clustering algorithms applied to alerts that have been collected from a plurality of security agents across different organizations. In the method of FIG. 7, the legitimate clusters are filtered from a base set of clusters that are generated from clustering algorithms applied to alerts that have been collected from a security agent or security agents of one organization.

As in the embodiment of FIGS. 2-4, the cluster profile data of legitimate clusters are stored in this embodiment in a memory space that is accessible by the security agent (e.g., as depicted in FIG. 5, memory space 281 in the VM where security agent 261 is installed). In addition, the same filtering techniques as in the embodiment of FIGS. 2-4 are implemented to identify the legitimate clusters. Here, however, the filtering techniques are applied by an alert filter module implemented in the security agent (e.g., alert filter module 590) instead of alert service 210.

The method of FIG. 7 is carried out by a security agent (e.g., any of security agents 261, 262, 263) after its alert filter module performs the filtering described above and stores the cluster profile data of legitimate clusters in the memory space accessible by the security agent, and is triggered when the security agent generates an LSH security alert as described above, e.g., when the conditions of any of the watchlist rules are satisfied. At step 710, the security agent compares the LSH value of the security alert with the cluster profile data of legitimate clusters to determine if the security alert belongs to any of the legitimate clusters. Any of the well-known techniques may be used to determine whether the security alert belongs to any of the legitimate clusters. In one embodiment, the security agent performs distance calculations between the security alert and the legitimate clusters (in particular, between the LSH value of the security alert and centroids of the legitimate clusters), and determines that the security alert does not belong to any of the legitimate clusters if all of the calculated distances are greater than a threshold distance. On the other hand, if one or more of the calculated distances are within the threshold distance, the security alert is determined to belong to the legitimate cluster that is closest thereto.

If the security alert belongs to a legitimate cluster, the security alert is deemed to be a “noisy” alert that can be suppressed. Thus, if the security alert is a noisy alert (step 712, Y), the security agent at step 714 suppresses the security alert and permits the activity that triggered the security alert, e.g., permits execution of a command. The method ends after step 714.

On the other hand, if the security alert is deemed not to be a noisy alert (step 712, N), one of four options are available, and the security agent carries out the method of FIG. 7 according to an option setting (which is set, for example, by a security administrator of the VM in which the security agent is installed).

If option 1 is set (step 716, Y), the security agent compares the LSH value of the security alert with the cluster profile data of other clusters (i.e., those which were not determined to be legitimate clusters but also not known to be associated with malicious activities), and performs distance calculations between the security alert and these other clusters to determine if the security alert belongs to any of these other clusters in the same manner as carried out at step 710 described above. If the security alert belongs to any of these other clusters, it is deemed to be a noisy alert at step 712 and the security agent executes step 714 thereafter. If the security alert does not belong to any of these other clusters, the activity that triggered the security alert is deemed to be potentially malicious and the security agent executes step 728 next to block the activity. Some embodiments, however, may permit option 2 or option 3 to be set in addition to option 1. In such cases, the steps associated with option 2 or option 3 will be additionally executed as described below.

If option 2 is set (step 720, Y), the security agent at step 722 requests VM management server 130 to perform multi-factor authentication (MFA) on the activity that triggered the security alert. For example, if a command line is entered for execution and this activity triggered the security alert, VM management server 130 executes a series of MFA steps to confirm that the user that entered this command line is a legitimate user and not an attacker. If MFA is successful, the activity will be permitted. However, if MFA is not successful, the activity will be blocked.

If option 3 is set (step 424, Y), the security agent at step 426 requests a notification service running in the security agent (e.g., notification service 550 depicted in FIG. 5) to notify security operation center 201 associated with the customer environment in which the security alert was generated. In this case, a further investigation of the activity that triggered the security alert and a decision whether to permit the activity or block the activity will be carried out there.

In the embodiments, a security alert is processed without exposing the raw contents of the security alert. Therefore, the privacy of any sensitive information contained in the security alert is maintained. In addition, embodiments are applicable to behavioral events, which are fundamentally different from files and spams, which are objects of typical security software. The techniques described herein are also scalable. Forming the cluster profiles and reducing the search space enables security analysis to be performed on new events hitting client devices in real-time.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, NAS, read-only memory (ROM), RAM (e.g., flash memory device), Compact Disk (e.g., CD-ROM, CD-R, or CD-RW), Digital Versatile Disk (DVD), magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, modifications, additions, and improvements may fall within the scope of the appended claims.

What is claimed is:

1. A method of filtering out new alerts generated by a security agent installed in an endpoint, based on cluster profile data of clusters that were generated by applying a clustering algorithm to locality-sensitive hash (LSH) values of prior alerts, said method comprising:
storing cluster profile data of each cluster that is part of a subset of the clusters;
generating an LSH value of a new alert generated by the security agent; and
determining that the new alert belongs to one of the clusters in the subset based on the stored cluster profile data and the LSH value of the new alert and, in response to said determining, filtering out the new alert from a group of alerts that require further investigation.

2. The method of claim 1, further comprising:
determining that another new alert generated by the security agent does not belong to any one of the clusters in the subset based on the LSH value of said another new alert and, in response to said determining, blocking execution of a command that triggered generation of said another new alert.

3. The method of claim 1, further comprising:
determining whether or not another new alert generated by the security agent belongs to one of the clusters in the subset based on the LSH value of said another new alert; and
in response to determining that said another new alert does not belong to any one of the clusters in the subset based on the LSH value of said another new alert, requesting multi-factor authentication of a command that triggered generation of said another new alert.

4. The method of claim 1, further comprising:
determining whether or not another alert generated by the security agent belongs to one of the clusters in the subset based on the LSH value of said another new alert; and
in response to determining that said another new alert does not belong to any one of the clusters in the subset based on the LSH value of said another new alert, transmitting a notification indicating that said another new alert does not belong to any one of the clusters in the subset.

5. The method of claim 1, further comprising:
determining whether or not another alert generated by the security agent belongs to one of the clusters that are not malicious, based on the LSH value of said another new alert;
in response to determining that said another new alert belongs to one of the clusters that are not malicious, based on the LSH value of said another new alert, filtering out said another new alert from the group of alerts that require further investigation; and
in response to determining that said another new alert does not belong to any one of the clusters that are not malicious, based on the LSH value of said another new alert, blocking execution of a command that triggered said another new alert.

6. The method of claim 5, wherein
the clusters that are not malicious include all the clusters in the subset and other clusters, and
the cluster profile data of the clusters in the subset are stored in a memory space that is accessible by the security agent.

7. The method of claim 6, wherein the cluster profile data of the other clusters are also stored in the memory space that is accessible by the security agent.

8. The method of claim 6, wherein the cluster profile data of the other clusters are stored in a cloud platform.

9. The method of claim 6, wherein an average cluster density of the clusters in the subset is greater than an average cluster density of the other clusters.

10. The method of claim 6, wherein an average cluster variance of the clusters in the subset is less than an average cluster variance of the other clusters.

11. A computer system including a processor and a memory device, wherein the processor executes instructions of a security agent stored in the memory device, to carry out a method of filtering out alerts generated by the security agent based on cluster profile data of clusters that were generated by applying a clustering algorithm to locality-sensitive hash (LSH) values of prior alerts, said method comprising:
storing in the memory device cluster profile data of each cluster that is part of a subset of the clusters;
generating an LSH value of a new alert generated by the security agent; and
determining that the new alert belongs to one of the clusters in the subset based on the stored cluster profile data and the LSH value of the new alert and, in response to said determining, filtering out the new alert from a group of alerts that require further investigation.

12. The computer system of claim 11, wherein the method further comprises:
determining that another new alert generated by the security agent does not belong to any one of the clusters in the subset based on the LSH value of said another new alert and, in response to said determining, blocking execution of a command that triggered generation of said another new alert.

13. The computer system of claim 11, wherein the method further comprises:
determining whether or not another new alert generated by the security agent belongs to one of the clusters in the subset based on the LSH value of said another new alert; and
in response to determining that said another new alert does not belong to any one of the clusters in the subset based on the LSH value of said another new alert, requesting multi-factor authentication of a command that triggered generation of said another new alert.

14. The computer system of claim 11, wherein the method further comprises:
determining whether or not another alert generated by the security agent belongs to one of the clusters in the subset based on the LSH value of said another new alert; and
in response to determining that said another new alert does not belong to any one of the clusters in the subset based on the LSH value of said another new alert, transmitting a notification indicating that said another new alert does not belong to any one of the clusters in the subset.

15. The computer system of claim 11, wherein the method further comprises:
determining whether or not another alert generated by the security agent belongs to one of the clusters that are not malicious, based on the LSH value of said another new alert;
in response to determining that said another new alert belongs to one of the clusters that are not malicious, based on the LSH value of said another new alert, filtering out said another new alert from the group of alerts that require further investigation; and
in response to determining that said another new alert does not belong to any one of the clusters that are not malicious, based on the LSH value of said another new alert, blocking execution of a command that triggered said another new alert.

16. The computer system of claim 15, wherein
the clusters that are not malicious include all the clusters in the subset and other clusters, and
the cluster profile data of the other clusters are also stored in the memory device.

17. The computer system of claim 15, wherein
the clusters that are not malicious include all the clusters in the subset and other clusters, and
the cluster profile data of the other clusters are stored in a cloud platform.

18. A non-transitory computer readable medium comprising instructions of a security agent that are executable in a processor of a computer system, to carry out a method of filtering out alerts generated by the security agent based on cluster profile data of clusters that were generated by applying a clustering algorithm to locality-sensitive hash (LSH) values of prior alerts, said method comprising:
storing cluster profile data of each cluster that is part of a subset of the clusters;
generating an LSH value of a new alert generated by the security agent; and
determining that the new alert belongs to one of the clusters in the subset based on the stored cluster profile data and the LSH value of the new alert and, in response to said determining, filtering out the new alert from a group of alerts that require further investigation.

19. The non-transitory computer readable medium of claim 18, wherein
the clusters include all the clusters in the subset and other clusters, and
an average cluster density of the clusters in the subset is greater than an average cluster density of the other clusters.

20. The non-transitory computer readable medium of claim 18, wherein
the clusters include all the clusters in the subset and other clusters, and
an average cluster variance of the clusters in the subset is less than an average cluster variance of the other clusters.
